(19) United States
(12) Patent Application Publication
(10) Pub. No.: US 2006/0247051 A1
(43) Pub. Date: Nov. 2, 2006

(54) Method for controlling programs of a mobile game client

(76) Inventors: Qian Liu, Shenzhen (CN); Qian Sun, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/397,731

(22) Filed: Apr. 5, 2006

(30) Foreign Application Priority Data
Apr. 9, 2005 (CN) 200510034190.X

(51) Int. Cl. A63F 13/00; G06F 19/00; A63F 9/24; G06F 17/00

(52) U.S. Cl. 463/40

(57) ABSTRACT

The present invention discloses a program control method for mobile game client, which comprises the steps of: setting one or more active zones in a game map of a mobile game client, and setting a function identity corresponding to an application program for each of said active zones; obtaining and running an application program corresponding to a function identity for an active zone when detecting that a distance between the location of a game role and the active zone is shorter than a preset threshold. By setting active zones in a graphic game map as entrances to various mobile games or other related applications instead of directly integrating various mobile games with a graphic game map, this invention implements the effective calling in of various mobile games or other related applications from a graphic game map under the circumstances of existing mobile terminals.

### CROSS-REFERENCE TO RELATED APPLICATIONS

This application claims priority to Chinese Patent Application No. 200510034190, filed Apr. 9, 2005. the disclosure of which is hereby incorporated by reference in its entirety.

### FIELD OF THE INVENTION

The present invention relates to mobile game program controlling techniques, and more particularly, to a method for controlling programs of a mobile game client.

### BACKGROUND OF THE INVENTION

Mobile game is a kind of electronic game service operated by users via mobile communication network on platforms of mobile terminals, such as mobile phones or PDAs. For example, mobile games include chess and poker games, sports games, adventure games, and pet games on mobile phones. Since mobile game is network based, portable, easily charged, and has a potentially huge user group, it has become one of the major applications in the future 3G commercial market with immeasurable commercial prospect. Meanwhile, along with the development of network and terminal technology, graphic mobile game appears and is getting popular, for example, mobile-phone games based on K-JAVA (Java 2 Micro Edition) technology are genuine graphic games instead of games with only static pictures and fixed words like the previous short-message games or WAP (Wireless Application Protocol) games. Images in some graphic games are even comparable to the images in the portable video game machine of Nintendo GBA.

During developments of graphic mobile games, the graphic game map simulating the real world (also referred to as virtual community) is no doubt the most attractive mobile game circumstance. As there is such a good assortment of mobile games provided on mobile terminals, it is in a trend of making mobile games operated as in a supermarket by using graphic game map as a portal entrance to various mobile games. It is a knotty problem in the prior art, however, to integrate various mobile games into the graphic game map simulating the real world.

### SUMMARY OF THE INVENTION

The present invention provides a method for controlling programs of a mobile game client. The method for controlling programs of a mobile game client comprises the following steps:

setting one or more active zones in a game map of a mobile game client, and setting a function identity corresponding to an application program for each of said active zones;

obtaining and running an application program corresponding to a function identity of an active zone when a distance between a location of a game role and the active zone is shorter than a preset threshold.

In accordance with the present invention, active zones are set in a game map data of a mobile game client, and a function identity corresponding to at least one application programs are set for each active zone; when it is detected that the distance between the location of a game role and the active zone is less than a preset threshold, the application program corresponding to the appropriate function identity for the active zone is obtained and run. Thus, by setting active zones in graphic game map as entrances to various mobile games or other related application programs instead of integrating various games with a graphic game map, this invention makes it possible to implement the effective calling in of various mobile games or other related application programs under the existing circumstances of mobile equipments (i.e. types of mobile terminals vary greatly and the common mobile stations usually have insufficient memory and computation capability).

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart of the method for controlling programs on mobile game client in accordance with the embodiment of the present invention;

FIG. 2 is a flowchart of an embodiment of configuring a gamebox as an active zone in a game map in accordance with the embodiment of the present invention;

FIG. 3 is a flowchart of manipulating a mobile game on a functional building in a game map via a mobile game client in accordance with the embodiment of the present invention.

### DETAILED DESCRIPTION OF PREFERRED EMBODIMENT

In order to make the object, technical solution and merits of this invention clearer, a further detailed description of this invention is hereinafter given with reference to the accompanying drawings and embodiments.

The method for controlling programs of a mobile game client in accordance with the embodiment of the present invention comprises two major steps:

Step A: setting at least one active zone in a game map on a mobile game client, and sets a function identity corresponding to at least one application program for each active zone;

Step B: when detecting that the distance between the location of a game role and an active zone is shorter than a preset threshold, obtaining and running the application program corresponding to the function identity of the active zone.

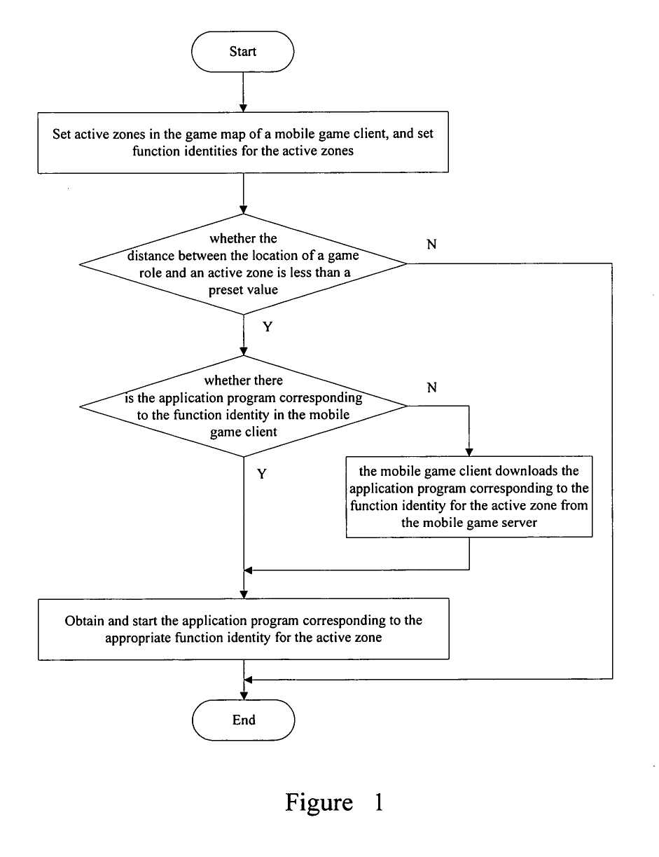

For a better understanding, the method of this invention is further divided into the following steps as shown in FIG. 1, which is a flowchart of the method for controlling programs of a mobile game client in accordance with the present invention.

Step 101: setting at least one active zone (or referred to as hot-spot zone) in the game map on a mobile game client, and setting a function identity corresponding to an application program for each active zone.

Step 102: detecting whether the distance between the location of a game role and an active zone is shorter than a preset threshold, if the distance is shorter than the preset threshold, proceeding to Step 103; otherwise, making no processing.

Step 103: determining whether the application program corresponding to the appropriate function identity of the active zone existing on the mobile game client, if existing, proceeding to Step 105, otherwise, proceeding to Step 104.

Step 104: downloading the application program corresponding to the appropriate function identity of the active zone from the mobile game server before proceeding to Step 105.

Step 105: obtaining and running the application program corresponding to the appropriate function identity of the active zone.

Graphic game map simulating the real world is the indispensable game circumstance of a mobile game. In accordance with the present invention, the game map data may include four types of graphic components, i.e. scenes, buildings, scene blocks, and elements. Herein, it is necessary to give a detailed description of the four types of graph components.

Scenes: each game map may be divided into multiple scenes, and each scene is an independent unit that can be downloaded. A scene consists of at least one building, and it is likely to enter another scene via a building of this scene. Game map data include scene records, referred to as SceneTab, which contain such information as SceneID, SceneName, SceneDesc, TerminalType, and the shape of a scene. An example of SceneTab is shown as Table 1.

TABLE 1
SceneTab

| Field name | Type | Description |
|---|---|---|
| SceneID | Number | Scene identity |
| SceneName | Character string | Scene name |
| SceneDesc | Character string | Description of scene |
| TerminalType | Number | Type of terminal |
| Width | Number | Width of scene |
| Height | Number | Height of scene |

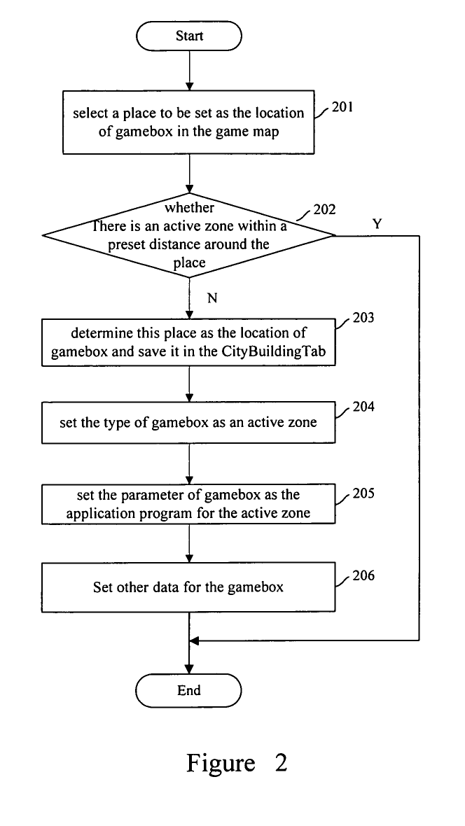

Buildings: there are four types of buildings: functional buildings, decorating buildings, and entrance buildings. Functional buildings (e.g. game boxes) correspond to mobile games or other relevant application programs of game systems, where the mobile games include chess and pokers, mahjong game, and etc.; and other relevant application programs include chat room program, instant messenger program, calculator, and etc. Decorating buildings are only used for in decorating scenes, e.g. lawns, woods, and etc. Exit buildings are used as passages for entering another scene, e.g. door. Game map data include building records, referred to as CityBuildingTab, which contains such information as building identity, building name, location of building, shape of building, identity of advertising place, graphic layer attribute of building, identity of the scene to which the building belongs, type of building, parameter of building, and appropriate elements. An example of CityBuildingTab is shown as FIG. 2, where the zone in which the building locates is determined by the location information (coordinates) and shape information of building in the CityBuildingTab; advertising information of game map may be configured dynamically by the identity of advertising place of the building; and graphic layer attribute of building is further configured for a building so that scenes could be constructed according to the graphic layer attribute in the game map and could further display dynamical conditions, e.g. a condition where a graphic element shields a game role.

TABLE 2
CityBuildingTab

| Field name | Type | Description |
|---|---|---|
| BuildingID | Number | Building identity |
| BuildingName | Character | Building name |
| | string | |
| X | Number | Coordinate x of the building in a scene |
| Wiring | Number | Coordinate y of the building in a scene |
| Width | Number | Width of the building |
| Height | Number | Height of the building |
| AdLocID | Number | Identity of advertising place if there is an |
| | | advertising place in the building |
| Layer | Number | Layer on which the building locates. |
| | | Each scene may be divided into multiple |
| | | layers, and each building may only belong to |
| | | a specific layer. |
| SceneID | Number | Identity of the scene to which the building |
| | | belongs |
| ParamType | Number | Type of the object represented by the |
| | | building, mainly used for processing on a |
| | | client |
| Param | Character | Input parameters needed for implementing |
| | string | the building |
| ElementID | Number | If a building consists of one graphic |
| | | element, this ID denotes the graphic element |
| | | identity in the GraphicElementTab; if the |
| | | building consists of multiple graphic |
| | | elements, this ID denotes the building |
| | | element identity in the BuildingElementTab. |
| DestSceneID | Number | Identity of other scenes denoted by the |
| | | building, if the building denotes no other |
| | | scene, this value is invalid. |
| DestBlockID | Number | If DestSceneID is valid, this ID denotes the |
| | | location of the user after entering the scene |
| | | denoted by DestSceneID. |

Elements: the above mentioned building consists of one or more elements. An element can be downloaded separately and saved in a mobile game client. The advantage of decomposing a scene into buildings or elements is that, in doing so, the amount of information constituting a scene is less than that of a scene constituted by an entire picture, the downloading speed at the mobile game client is faster, and the memory occupied is less. In addition, when a certain element of a scene on the mobile game client is modified, it is possible for the client to update only the modified element, instead of updating the entire scene, thereby shortening the downloading time and making it possible to extend a scene flexibly.

Elements are further divided into graphic elements and building elements, where a building element consists of at least two graphic elements, and the building in a building record corresponds to the identity of a graphic element or a building element so as to determine the display image of the building. The building element is mainly for the convenience of editing by the map editor. When several graphic elements are combined to a building element, the building element can be taken as a whole. The mobile game client can not sense the existing of a building element and the building element record will not be sent to the mobile game client. Thus a building consists either of a graphic element or a building element.

The game map data include graphic element records, referred to as GraphicElementTab, which contains such information as graphic element identity, graphic element data (display image of graphic element), and style of graphic element. An example of GraphicElementTab is shown as Table 3a.

TABLE 3a
GraphicElementTab

| Field name | Type | Description |
|---|---|---|
| ElementID | Number | Graphic element identity |
| Element | Binary | Graphic element data |
| | number | |
| Style | Number | Style of graphic element, scenes of one style can |
| | | only use graphic elements of the same style |
| | | (cartoon, classic, and etc.) |

The game map data include also building element records, referred to as BuildingElementTab, which contain such information as serial number, building element identity, graphic element identity, location of graphic element, and serial number of graphic element. An example of BuildingElementTab is shown as Table 3b.

TABLE 3b
BuildingElementTab

| Field name | Type | Description |
|---|---|---|
| SNO | Number | Serial number, mainly for uniquely |
| | | denoting a record, as the master key of the |
| | | BuildingElementTab |
| BuildingElementID | Number | Building element identity. If a building |
| | | element consists of three graphic elements, |
| | | there will be three records with identical |
| | | building element identities. |
| ElementID | Number | Graphic element identity, denoting the |
| | | identity of the graphic element |
| | | constituting the building element |
| Offset X | Number | Offset of coordinate x of the graphic |
| | | element in the building element. The |
| | | upper left corner of a building element is |
| | | the origin of coordinate, which is mainly |
| | | for the mobile game client to draw the |
| | | graphic element when generating the |
| | | building element. |
| Offset Y | Number | Offset of coordinate y of the graphic |
| | | element in the building element. |
| Loc | Number | Serial number of the graphic element in |
| | | the building element, for the mobile game |
| | | client to make a drawing. The sheltering |
| | | relation between graphic elements can be |
| | | kept normal in the building element when |
| | | the drawing is based on the serial number |
| | | of each graphic element. |

Scene blocks: each scene can be divided into multiple regular scene blocks. In this embodiment, two sets of parallel lines are used to divide the scenes so that each scene is divided into scene blocks of rectangles or common parallelograms, and each scene block is of the same size. The major advantage of scene block lies in that it is convenient for a mobile game client to control the walking of a game role of the mobile game client and determine the shortest path for the game role to walk. The distance of one step of the game role is the length of a scene block. There are two types of scene blocks: passable scene block and impassable scene block. The client should control the game role to walk passing by the impassable scene blocks. Preferably, the included angle between two sets of parallel lines dividing a scene into scene blocks may be 45 degrees or so since the viewing angle of a graphic game map is usually 45 degrees. The game map data include scene block records, referred to as SceneBlockTab, which contains such information as scene block identity, identity of scene to which the scene block belongs, identity of building to which the scene block belongs, type of the scene block, parameter of the scene block, and the semantic meaning of the building to which the scene block belongs. An example of SceneBlockTab is shown as Table 4.

TABLE 4
SceneBlockTab

| Field name | Type | Description |
|---|---|---|
| ID | Number | Scene block identity |
| SceneID | Number | Identity of the scene to which the scene |
| | | block belongs |
| BuildingID | Number | Identity of the building to which the scene |
| | | block belongs. BuildingID is meaningful |
| | | only when Flag >= 3 and is not |
| | | equal to 11. |
| SceneParamType | Number | Type of scene block, mainly for |
| | | processing on client |
| Sceneparam | Character | Input parameter needed for implementing |
| | string | the scene block |
| Flag | Number | Semantic meaning of the building to |
| | | which the scene block belongs |
| | | 1: passable, 2: impassable, 3: entrance |

The above four types of graphic components are saved in the database records on the mobile game server. When a user succeeds in ordering a game service, the mobile game terminal downloads from the mobile game server (or special download server, e.g. KJava Download Server) the data package of mobile game client, installs and runs the mobile game client, logs on the mobile game server using an account and a password, and then, after passing authentication, displays an initial picture of game map (this picture may be contained in the downloaded data package of the mobile game client or may be downloaded from the mobile game server at the time of start-up) and an initial scene like my house. Furthermore, when the graphic components on the mobile game server are updated, the server may send a message to inquire whether the mobile game client desires to update accordingly, thereby implementing a synchronized updating of the server and the client.

Hereinafter, each specific step of the method for controlling programs on mobile game client shown in FIG. 1 is described in detail.

Step 101: setting at least one active zone in the game map of a mobile game client, and setting function identity corresponding to an application program for each active zone.

The first method for setting an active zone in the game map comprises: setting at least one building in the scene as an active zone, and setting function identity corresponding to mobile game or other related application program for the active zone.

As shown in Table 2, the type of building (ParamType) has been recorded in the CityBuildingTab, and indicates the type of the object represented by the building. More important, said ParamType indicates whether this building is an active zone. In this embodiment, ParamType further comprises:

1. decorating building;

2. community public service;

3. community value-added service;

4. game classification;

5. game service;

6. game room (or game zone).

As shown in Table 2, the parameter of building (Param) has been recorded in the CityBuildingTab, and indicates the input parameters needed for implementing the function corresponding to the building, i.e. indicates the function identity of the application program corresponding to the building.

1. If the ParamType is decorating building, the Param is meaningless.

2. If the ParamType is community public service, the Param takes the value of the function identity corresponding to such application programs as TV, game box, wardrobe, calculator, personal information, bulletin board, and forum, which are functions without charging, i.e. free services.

3. If the ParamType is community value-added service, the Param is the identity of a value-added community service, e.g. the identity of the application program of chat room, which may be charged by the mobile game server based on the recorded time of a user using the value-added service.

4. If the ParamType is game classification, the Param indicates a specific game type, and the mobile game client displays the game list of that type.

5. If the ParamType is game service, the Param indicates the identity of a specific game service, and the mobile game client enters the game directly.

6. If the ParamType is game room or game zone, the Param indicates the identity of a specific game room (or game zone), and the game client enters the game room or game zone directly.

As can be seen above, all types of building may be active zones except decorating building. Thus, a number of buildings may be selected and configured in the game map data, where the types of building are configured as active zones and the parameters of the buildings are configured as the function identities of application programs corresponding to the active zones.

In addition, when setting an active zone in the game map data of a mobile game client, detecting firstly whether there exists another active zone within a preset distance around the active zone to be set, if there exists an active zone, forbidding setting the active zone, otherwise allowing setting the active zone, so as to avoid such a mistake as running two application programs at the same time by a game role due to the unduly short distance between two active zones. The preset distance is usually determined according to specific conditions and should be at least greater than the preset threshold set between the location of a game role and an active zone in Step 102, for example, the preset distance is set as the length of two or three scene blocks.

Refer to FIG. 2, and an example of setting a building of gamebox as an active zone in the game map is hereinafter described:

Step 201: selecting a place in the game map to be configured as the location of a gamebox via the map editor.

Step 202: determining whether there exist other active zones within a preset distance around the place, if not, proceeding to Step 203, otherwise making no processing;

Step 203: setting the place as the location of the gamebox and saving the place in the CityBuildingTab;

Step 204: setting the type of the gamebox as an active zone via the map editor;

Step 205: setting the Param of the gamebox as the application program corresponding to the active zone via the map editor;

Step 206: further setting other data for the gamebox, e.g. the gamebox identity, the gamebox name, and etc. It should be understood that this step may also be performed before Step 203 or between Step 203 and Step 204.

The second method for setting an active zone in the game map is as follows: setting at least one scene block in a scene as an active zone, and setting function identity corresponding to mobile games or other related programs for this active zone.

As shown in Table 4, the type of the scene (SceneParamType) has been recorded in the SceneBlockTab, and the SceneParamType indicates whether the scene block is an active zone.

As shown in Table 4, the parameters of the scene (SceneParam) has been recorded in the SceneBlockTab, and the SceneParam indicates the input parameters needed for implementing the function corresponding to the scene block, i.e. indicates the function identity of the application program corresponding to the scene block.

Since the specific contents of a SceneParamType and a SceneParam are basically the same as the specific contents of a ParamType and a Param of building, no further description is given here. Furthermore, a scene block can be configured with a dynamic attribute (i.e. the Flag of a scene block), e.g. passable or impassable, or whether it is an entrance. It should be noted that, since a scene block is of a regular shape, which is convenient for the mobile game client to find the optimum path and control the game role's walking steps, a better control is easily achieved by setting regular scene blocks as the active zones, thereby simplifying the controlling program.

Step 102: detecting the distance between the location of a game role and the active zone, which may be implemented in three ways:

Firstly, detecting with the mobile game client whether the distance between the location of a game role and the active zone is shorter than the preset threshold, if yes, proceeding to Step 103; otherwise, making no processing.

Secondly, detecting with the mobile game client whether the distance between the location of a game role and the active zone is shorter than the preset threshold, and sending the detecting result to the mobile game server, if the distance is shorter than the preset threshold, proceeding to Step 103; otherwise, making no processing.

Thirdly, detecting with the mobile game server whether the distance between the location of a game role and the active zone submitted by the mobile game client is shorter than the preset threshold, if yes, sending the detecting result to the mobile game client and proceeding to Step 103; otherwise, making no processing.

The border of an active zone may be determined by the coordinates and the width and height of the building, and the distance between the location of a game role and the active zone may be determined by comparing the coordinates of the current location of the game role with the border of the active zone, for example, detecting whether the location coordinates of the game role are close to or have fallen within the border of the active zone.

Since many buildings are impassable, e.g. gamebox and bookshelf, a game role can not actually enter the zone of the building or can only enter a very small portion thereof, which brings inconvenience to operation. Therefore, the method for detecting the distance between the location of a game role and the active zone may comprise: detecting the building or scene block existed within a range of preset value around the game role, if there exists a building or scene block having function identity, running the corresponding application program. The preset value should be properly set, and it is inadvisable to set a too big value, otherwise there will be a mistake of detecting two active zones within the range of preset value at the same time. Though the above preset value may be set according to actual conditions, the preset value of the distance between the location of the game role and the active zone must be shorter than half of the preset distance between said active zones in Step 101.

It should be noted that there are advantages and disadvantages in all the above three ways of detecting the distance between the location of a game role and the active zone. That is, there exists the issue of synchronization between the game server and the game client no matter which one of the two detects the distance. The so-called synchronization is to keep the data on the game client consistent with the data on the game server, and the importance of the data synchronization between the game server and the game client is obvious. Basically there are two ways to keep the data synchronization: one is that the game server keeps updating the data of the user and then sending the updated data to the game client; the other is that the game client calculates the data of the user and then sends the data to the game server. The former method is called the controlling method, i.e. the game server controls the game client; the latter is called the storing method, i.e. the game server only stores the data sent from the game client. The storing method has prominent advantages, which sharply reduces the load of a mobile game server and there is much less requirements for synchronization. In the controlling method, data are strictly controlled by a mobile game server while a mobile game client is only in charge of displaying the figures.

In all the above three methods, the detection is conducted by determining whether the distance between the location of a game role and the active zone is shorter than a preset threshold. It should be understood that the mobile game server or game client may also detect and determine whether the location coordinates of a game role are within the active zone so as to determine whether to proceed to Step 103.

Steps 103˜104: determining whether the application program corresponding to the appropriate function identity of the active zone exists on the mobile game client, if exists, proceeding to Step 105; otherwise, it is necessary for the client to download the application program corresponding to the appropriate function identity of the active zone from the mobile game server (or KJAVA download server).

Preferably, if it is determined in Step 103 that the application program corresponding to the appropriate function identity of the active zone exists on said mobile game client, the game client sends the version number of the application program on the game client to the game server. The game server will then determine whether this version of the application program is the latest, if it is not the latest, sending a message to prompt the game client to choose whether to download the latest version of the application program, if the client chooses to download the latest version, the latest version of the application program will be downloaded from the game server to the game client; otherwise, directly proceeding to Step 105.

Step 105: obtaining and running the application program corresponding to the appropriate function identity of the active zone.

Said mobile game server and/or mobile game client may save the attribute records of a game role, e.g. the credits, gender, status, terminal type of a game role. Then setting function identity corresponding to application program for the active zone may further comprise the attribute activation condition of corresponding game role so as to determine whether to run the application program. For example, a game room may only allow the game roles with certain credits to enter, or a game permits only female game roles to enter. In such cases, the credits or gender of a game role may be used as the attribute activation condition of a game role, and before running the application program corresponding to the appropriate function identity of the active zone, it is necessary to check the above attribute activation setting. Only when the attribute of the game role conforms to the attribute activation condition will the mobile game client run the mobile game or related application program corresponding to the function identity of the active zone; otherwise, give a prompt of the reason for being unable to run the application program or just make no processing.

Furthermore, said setting function identity corresponding to application program for each active zone may comprise configuring each function identity as corresponding to multiple mobile games or related application programs. Meanwhile, the function identity configures different attribute activation conditions of game roles for each kind of application program, and the mobile game client will enter different application programs according to the attribute activation conditions of the game role thereof. For example, allow a game role to enter different application programs according to different credits of the game role or to enter the game room corresponding to the level of credits, where each level of credits is set as the attribute activation condition of a game role, respectively; alternatively a game role may be allowed to enter the same game of different styles according to the age or gender of the game role, where the age range or gender may be set as the attribute activation condition of a game role.

After running the application program corresponding to the appropriate function identity of the active zone, updating synchronously the attribute records of the game role on the mobile game server and the mobile game client. For example updating the credits of the game role so that new credits may be used in the next running of the application program. In the end, exiting the application program and returning to the main program of the game map.

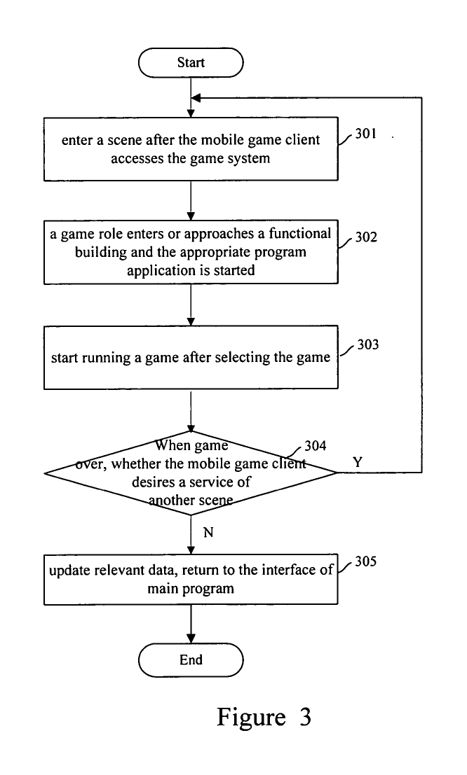

Referring to FIG. 3, an example of a mobile game client making mobile game operation on a functional building in the game map is described below.

Step 301: after accessing a game system, a mobile game client enters an initial scene, e.g. the scene of my house. The scene of my house may include such buildings as floor, wall, gamebox, furniture, and electronic appliance.

Step 302: when a controlled game role enters or approaches a functional building, e.g. a gamebox, the corresponding application program will be run. At the same time, pressing a certain button to activate function selection, and the mobile game client will display, according to the attribute of the gamebox, the games or application programs that can be run by the user, such as, displaying the list of the mobile games that can be selected. In fact, the gamebox building may directly correspond to a specific game, such as grappling game, and when a controlled game role enters or approaches the zone of the gamebox building, the corresponding game will be run directly.

Step 303: after selecting a game, the mobile game client may start to run the game, such as, the gobang game and the grappling game.

Step 304: when the game is over, if the mobile game client desires other services in the same scene, the game client may select another service in the same scene, and return to Step 301; if the mobile game client desires a service of another scene, the game role may be controlled to pass through an entrance building so as to enter another main scene and select the desired service, then return to Step 301. Here, the said another main scene may be a city square scene which may comprise such buildings as roads, grass and flowers, and supermarket. If the mobile game client desires no other services, proceeding directly to Step 305.

Step 305: updating the related data, and returning to the interface of main program.

As can be seen from the above embodiment, this invention uses the active zone set in the graphic game map as the entrance to mobile games and other related application programs instead of integrating various mobile games with a graphic game map, thereby effectively implementing the calling of various mobile games or other related application programs under the existing circumstances of mobile terminals (i.e. types of mobile terminals vary greatly and it is common that a mobile terminal has poor capability of memory and computation). Thus, this invention is conducive to the promotion of mobile games and brings much profit to the operators.

It is appreciated by those with ordinary skill in the art that various appropriate modifications may be made and other forms of the method may appear based on the technical solution and the spirit of this invention, and all the modifications and other forms of the method should therefore be covered in the protection scope of the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for controlling programs of a mobile game client, comprising:
setting one or more active zones in a game map of a mobile game client, and setting a function identity corresponding to an application program for each of said active zones;
obtaining and running an application program corresponding to a function identity of an active zone when a distance between a location of a game role and the active zone is shorter than a preset threshold.

2. The method according to claim 1, further comprising: dividing said game map into one or more scenes; wherein
each of said scenes comprises one or more buildings;
said step of setting one or more active zones includes: setting one or more buildings.

3. The method according to claim 2, wherein:
said game map corresponds to a game map data comprising one or more scene records and one or more building records, each of said scene records corresponding to said one or more building records;
each of said scene records comprises a scene identity;
each of said building records comprises a scene identity of the corresponding scene, a display image identity and a location of the building.

4. The method according to claim 3, wherein:
each of said building records further comprises a building type and a building parameter;
said step of setting one or more active zones and setting a function identity for each of said active zones includes: setting the building type of at least one building record so as to indicate said at least one building is an active zone, and setting the building parameter of said at least one building record so as to indicate the function identity for said at least one building.

5. The method according to claim 2, further comprising before said step of setting said one or more buildings as the active zones: detecting whether there exists an active zone within a preset distance around a building to be set as an active zone, if exists, prohibiting setting the building as an active zone; otherwise, allowing setting the building as an active zone.

6. The method according to claim 3, further comprising: dividing each of said scenes into one or more scene blocks;
wherein said step of setting one or more active zones includes: setting one or more scene blocks as the active zones.

7. The method according to claim 6, wherein said step of dividing each of said scenes into one or more scene blocks includes: dividing each of said scenes into one or more scene blocks by two sets of parallel lines.

8. The method according to claim 6, wherein:
the game map data further comprises one or more scene block records, and each of said scene block records corresponds to one scene record and one building record;
each of said scene block records comprises a scene block identity, a scene identity in the corresponding scene record and a building identity in the corresponding building record.

9. The method according to claim 8, wherein:
each of said scene block records further comprises a scene block type and a scene block parameter;
said step of setting one or more active zones and setting a function identity for each of said active zones includes: setting the scene block type of at least one scene block record so as to indicate said at least one scene block is an active zone, and setting the scene block parameter of said at least one scene block record so as to indicate the function identity for said at least one scene block.

10. The method according to claim 6, further comprising before said step of setting one or more scene blocks as the active zones: detecting whether there exists an active zone within a preset distance around a scene block to be set as an active zone, if exists, prohibiting setting the scene block as an active zone; otherwise, allowing setting the scene block as an active zone.

11. The method according to claim 3, wherein:
each of said building records corresponds to an element record which comprises an element identity;
the display image identity in each of said building records is the element identity in said corresponding element record.

12. The method according to claim 11, wherein:
said element record is a graphic element record;
said graphic element record comprises a graphic element identity and a graphic element display image;
the display image identity of each of said building records is the graphic element identity in said graphic element record.

13. The method according to claim 1.1, wherein:
said element record is a building element record corresponding to one or more graphic element records;
each of said graphic element records comprises a graphic element identity and a graphic element display image;
said building element record comprises a building element identity, a corresponding graphic element identity and location information;
the display image identity of each of said building records is the building element identity in said building element record.

14. The method according to claim 1, wherein said step of obtaining and running an application program includes: detecting with the mobile game client whether the distance between the location of the game role and the active zone is shorter than the preset threshold, and if the distance between the location of the game role and the active zone is shorter than the preset threshold, obtaining and running the application program for the active zone.

15. The method according to claim 1, wherein said step of obtaining and running an application program includes: detecting with the mobile game client whether the distance between the location of the game role and the active zone is shorter than the preset threshold, and sending the detecting result to a mobile game server, if the distance between the location of the game role and the active zone is shorter than the preset threshold, instructing the mobile game client to obtain and run the application program for the active zone with the mobile game server.

16. The method according to claim 1, wherein said step of obtaining and running an application program includes: detecting with a mobile game server whether the distance between the location of the game role and the active zone submitted by the mobile game client is shorter than the preset threshold, and if the distance between the location of the game role and the active zone is shorter than the preset threshold, sending the detecting result to the mobile game client with the mobile game server, and obtaining and running the application program for the active zone with the mobile game client upon receiving the detecting result.

17. The method according to claim 1, further comprising: storing at least one game role attribute record;
said step of setting a function identity for each of said active zones further comprising: setting a game role attribute activation condition for the function identity;
further comprising before said step of obtaining and running an application program: determining whether the game role attribute conforms to the game role attribute activation condition, and if the game role attribute conforms to the game role attribute activation condition, obtaining and running with the mobile game client the application program for the active zone.

18. The method according to claim 17, wherein said step of setting a game role attribute activation condition for the function identity includes: setting a game role attribute activation condition for each said application program corresponding to the function identity;
said step of obtaining and running an application program includes: obtaining and running the application program in which the game role attribute conforms to the game role attribute activation condition for the application program.

19. The method according to claim 18, further comprising after said step of obtaining and running an application program: updating the game role attribute record.

20. The method according to claim 19, wherein:
said step of storing the game role attribute record includes: storing the game role attribute record on the mobile game client and the mobile game server;
said step of updating the game role attribute record includes: making synchronized updating of the game role attribute record on the mobile game server and on the mobile game client.

21. The method according to claim 1, wherein said step of obtaining and running an application program includes: determining whether the application program exists in the mobile game client, if exists, directly running the application program; otherwise, downloading the application program from the mobile game server and running the application program.

22. The method according to claim 21, further comprising after determining that there exists the application program in the mobile game client: sending the version information of the application program existing in the mobile game client to a mobile game server, and determining with the mobile game server whether the version of the application program is the latest version, if it is not the latest version, sending a message to prompt the mobile game client to download the latest version of the application program from the mobile game server.

23. The method according to claim 1, wherein said distance between the location of a game role and an active zone being shorter than a preset threshold includes: the location coordinates of the game role being within the border of the active zone.
